(19) United States
(12) Patent Application Publication
(10) Pub. No.: US 2012/0060791 A1
(43) Pub. Date: Mar. 15, 2012

(54) LASER SPARK PLUG AND PRECHAMBER MODULE FOR SAME

(76) Inventors: Pascal Woerner, Korutal-Munchingen (DE); Manfred Vogel, Ditzingen (DE)

(21) Appl. No.: 13/256,810

(22) PCT Filed: Feb. 25, 2010
(86) PCT No.: PCT/EP10/52395

§ 371 Date: Nov. 28, 2011

(30) Foreign Application Priority Data
Apr. 3, 2009 (DE) 10 2009 002 167.1

(51) Int. Cl. F02B 19/12; F02P 23/04

(52) U.S. Cl. 123/260

(57) ABSTRACT

A laser spark plug, in particular for an internal combustion engine of a motor vehicle, having a prechamber and a laser device for emitting laser pulses into the prechamber. The laser device and/or the prechamber is/are designed to focus the laser pulses on a focus point located in the region of an inner surface of the prechamber.

### BACKGROUND INFORMATION

The present invention relates to a laser spark plug, in particular for an internal combustion engine of a motor vehicle, having a prechamber and a laser device for emitting laser pulses into the prechamber. Such a laser spark plug is described in German Patent Application No. DE 10 2006 018 973 A1. One disadvantage of the conventional laser spark plug is that laser pulses having a very high pulse energy must be generated in order to ensure reliable generation of an ignition plasma in the prechamber.

### SUMMARY

An object of the present invention is to improve a laser spark plug of the aforementioned type in such a way that ignition is reliably possible, even when laser pulses having fairly low pulse energy are used.

This object may be achieved according to an example embodiment of the present invention in that the laser device and/or the prechamber is/are designed to focus the laser pulses on a focus point located in the region of an inner surface of the prechamber. The configuration according to the example embodiment of the present invention advantageously allows reliable ignition by laser pulses, using less pulse energy compared to conventional systems, since particularly favorable flow conditions with low flow velocities prevail in the region of the inner surface. In addition, the provision according to the example embodiment of the present invention of the focus point results in particularly efficient combustion of the ignitable mixture contained in the prechamber, without a significant quantity of uncombusted gas being discharged from the prechamber into the combustion chamber. This is the case in particular when the focus point is located in the region of the inner surface of a region of the prechamber facing the combustion chamber, or in the region of the overflow holes.

In one particularly advantageous specific embodiment of the laser spark plug according to the present invention, in which a further reduction in the minimum pulse energy of the laser pulses necessary for reliable ignition is possible, it is provided that the laser device is designed to focus the laser pulses directly on the inner surface of the prechamber. For this purpose, the laser device may have a focusing lens whose focal length is coordinated with the geometry of the prechamber. Studies by the present applicant have shown that in this configuration, in which the plasma is generated directly on the surface of the prechamber material, the laser energy required for the ignition may be selected to be particularly low compared to the situation heretofore, in which the plasma is generated in the prechamber gas.

According to another advantageous specific embodiment, particularly long service lives of the laser spark plug according to the present invention may be achieved by the fact that the prechamber has a material buildup in the region of the focus point. Material wear in the region of the focus point is thus prevented by the selection according to the present invention of the focus point.

Even more efficient laser ignition is possible according to the present invention when the prechamber contains a sacrificial material in the region of the focus point which is different from the material used for forming the rest of the prechamber, in particular with respect to the absorption capability for the laser pulses and/or a melting temperature and/or further physical characteristics. The sacrificial material, which is generally metallic, is preferably selected in such a way that the generation of a metal plasma for igniting the prechamber gas is possible using particularly low pulse energies of the laser pulses. The shape and quantity of the sacrificial material should be selected so that favorable ignition conditions which are as uniform as possible are ensured, even under constant laser-induced erosion.

In another very advantageous specific embodiment of the laser spark plug according to the present invention, it is provided that the prechamber itself has a focusing arrangement for focusing the laser pulses. Providing the laser device with an appropriate focusing lens may thus advantageously be dispensed with. Instead, the laser device may advantageously be designed to emit the laser pulses onto the focusing arrangement of the prechamber in a generally unfocused manner, in particular as a parallel beam. A slightly divergent beam is also possible.

Alternatively, with the aid of the laser device the laser pulses may be focused on a point located outside the prechamber. In this case, a laser pulse having a nonvanishing beam cross section strikes the focusing arrangement of the prechamber, resulting in further focusing, for example combined with a reflection of the laser pulse. A focusing lens necessary for this purpose in the laser device, having a relatively long focal length, may be manufactured, with the same optical quality, much more easily than the focusing lenses having a much shorter focal length which are used in conventional laser spark plugs. The use of aspherical focusing lenses, for example, in the laser device may thus be dispensed with, which greatly reduces the manufacturing costs.

Particularly efficient focusing by the focusing arrangement of the prechamber is provided according to the present invention when the focusing arrangement situated in the prechamber is designed as a concave mirror, for example a parabolic reflector or a conical gap.

The provision according to the present invention of the focusing arrangement integrated into the prechamber advantageously allows the selection of a focus point which is directly situated in the region of an inner surface of the prechamber, resulting in a particularly favorable combustion inside the prechamber. In particular for concave mirror configurations, focusing means having extremely short focal lengths in the prechamber may be implemented.

To avoid undesirable pre-ignitions, the prechamber of the laser spark plug according to the present invention may have a very good thermal connection to the cylinder head of the internal combustion engine. For this purpose it is advantageous, for example, to design the laser spark plug in one piece with the prechamber. Further increase in heat dissipation from the region of the prechamber is achieved by the fact that the prechamber contains a highly thermally conductive material, in particular copper and/or brass.

To prevent soiling of a combustion chamber window or other optical components of the laser spark plug which adjoin the prechamber, a magnetic arrangement which binds magnetic particles generated during the laser ignition may advantageously be provided in the region of the prechamber. In this configuration of the laser spark plug according to the present invention, efficient cooling is important in order to keep the region of the prechamber containing the magnetic arrangement below the Curie temperature of the magnetic means. The magnetic arrangement may in particular have ring magnets and/or multiple individual magnets peripherally situated about a longitudinal axis of the laser spark plug which are designed in particular as rare earth magnets (neodymium, samarium-cobalt, for example), which may have Curie temperatures >400° C. The use of electromagnets is also possible. In addition to the binding of magnetic particles, the magnetic arrangement according to the present invention is also used to deflect electrically charged particles, for example ions from the combustion, away from the combustion chamber window.

The prechamber module according to an example embodiment of the present invention may be provided as a separate component and may be nondetachably connected to the rest of the laser spark plug during a manufacturing process, for example. Alternatively, the example prechamber module according to the present invention may have a design which is detachably connectable to the laser spark plug, with the aid of an appropriate screw connection, for example.

Further features, application options, and advantages of the present invention result from the description below of exemplary embodiments of the present invention which are illustrated in the figures. All described or illustrated features, alone or in any given combination, constitute the subject matter of the present invention, independently of their wording or illustration in the description or figures, respectively.

### BRIEF DESCRIPTION OF THE DRAWINGS

FIG. 1 shows a laser-based ignition system for an internal combustion engine of a motor vehicle having an example. laser spark plug according to the present invention.

FIG. 2a shows an enlarged view of an end region of the example laser spark plug according to the present invention from FIG. 1 facing the combustion chamber.

FIG. 2b shows a partial view of another specific embodiment of a laser spark plug according to the present invention.

FIG. 3 shows another specific embodiment of the laser spark plug according to the present invention.

FIG. 4 shows yet another specific embodiment of the laser spark plug according to the present invention, in which the prechamber has focusing means for focusing the laser pulses.

FIG. 5 shows another specific embodiment of the laser spark plug according to the present invention.

### DETAILED DESCRIPTION OF EXAMPLE EMBODIMENTS

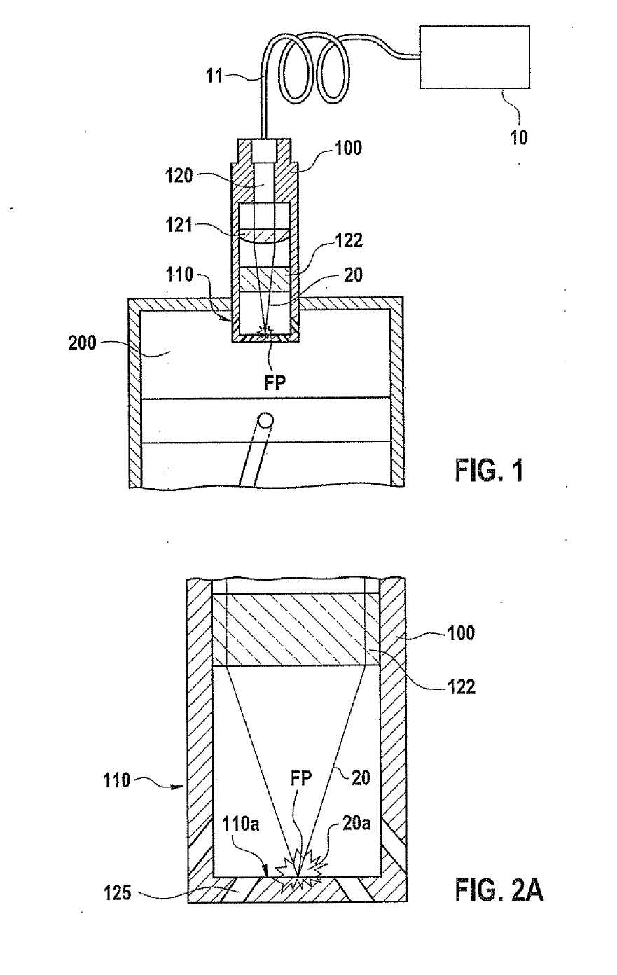

FIG. 1 shows a laser-based ignition system for an internal combustion engine of a motor vehicle. The ignition system has a pumped light source 10 which has a semiconductor diode laser, for example, for generating laser radiation for optical pumping of a laser device. The laser radiation generated by pumped light source 10 is relayed via an optical fiber device 11 to a laser device 120 which is integrated into laser spark plug 100 according to the present invention. Laser device 120 may be, for example, a laser-active solid having a passive Q-switch (not shown) via which high-power laser pulses 20 may be generated in a manner known per se.

Laser device 120 has a focusing lens 121 for focusing laser pulses 20 on a focus point FP situated in prechamber 110 of laser spark plug 100.

A combustion chamber window 122 is situated between focusing lens 121 and prechamber 110.

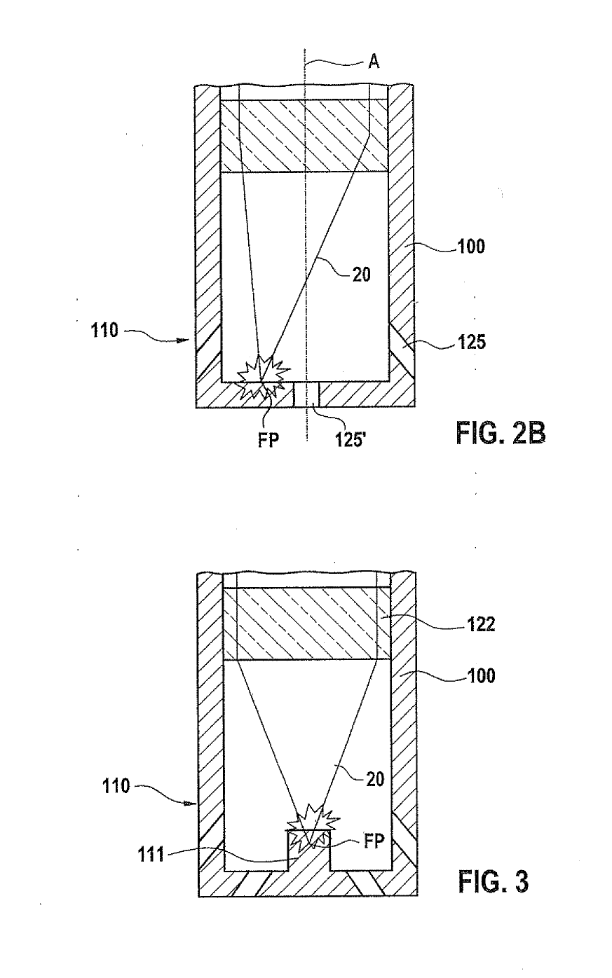

FIG. 2a shows an end region of laser spark plug 100 according to the present invention facing the combustion chamber, in an enlarged illustration. As is apparent from FIG. 2a, laser device 120, 121 according to the present invention (FIG. 1) is designed in such a way that it focuses laser pulses 20 on a focus point FP located in the region of inner surface 110a of prechamber 110, in the present case, directly on inner surface 110a. As the result of laser pulses 20 acting directly on inner surface 110a of prechamber 110, according to the present invention a metal plasma 20a is advantageously generated which is used for igniting an air/fuel mixture present in prechamber 110. For this purpose, in contrast to (gas) plasma generation in the conventional systems, in which the focus point is not located on a metallic surface, much lower laser power densities are required.

In this way, on the one hand the costs for laser device 120 may be reduced, and on the other hand the service life of laser spark plug 100 according to the present invention is increased.

Prechamber 110 of laser spark plug 100 has overflow passages 125 which establish a fluid connection between prechamber 110 and combustion chamber 200 (FIG. 1) in a manner known per se. The configuration, geometry, and quantity of overflow passages 125 is variable, and with the aid of flow simulations may be adapted to the requirements of the particular internal combustion engine.

For some combustion processes or combustion chamber geometries, it may be advantageous for prechamber 110 to have a central overflow passage 125′ (see FIG. 2b). To still allow reliable laser ignition, laser device 120 (FIG. 1) of laser spark plug 100 may advantageously be designed in such a way that focus point FP, as shown in FIG. 2b, is offset with respect to optical axis A of laser spark 100 so that the ignition may start in a flow region having relatively low flow velocities.

As the result of a tangential configuration of overflow passages 125, a swirl may also advantageously be generated in prechamber 110 which ensures improved admixture of fresh gas with the residual gas present in prechamber 110.

FIG. 3 shows another specific embodiment of laser spark plug 100 according to the present invention, in which a sacrificial material 111 is provided in the region of focus point FP which is different from the material used for forming the rest of prechamber 110, in particular with respect to the absorption capability for laser pulses 20 and/or a melting temperature and/or further physical characteristics.

In this way, in addition to the mere material provision which takes into account the increased wear due to the selection according to the present invention of focus point FP, improved plasma generation may be implemented at the same time by suitable material selection.

As an alternative or in addition to a separate sacrificial material, a material buildup 111 which is the same as the material forming prechamber 110 may be provided in the region of focus point FP, for example as the result of a localized enlargement of the wall thickness. The material removal caused by the laser-induced erosion is thus counteracted, which has a beneficial effect on the service life of prechamber 110 and entire laser spark plug 100.

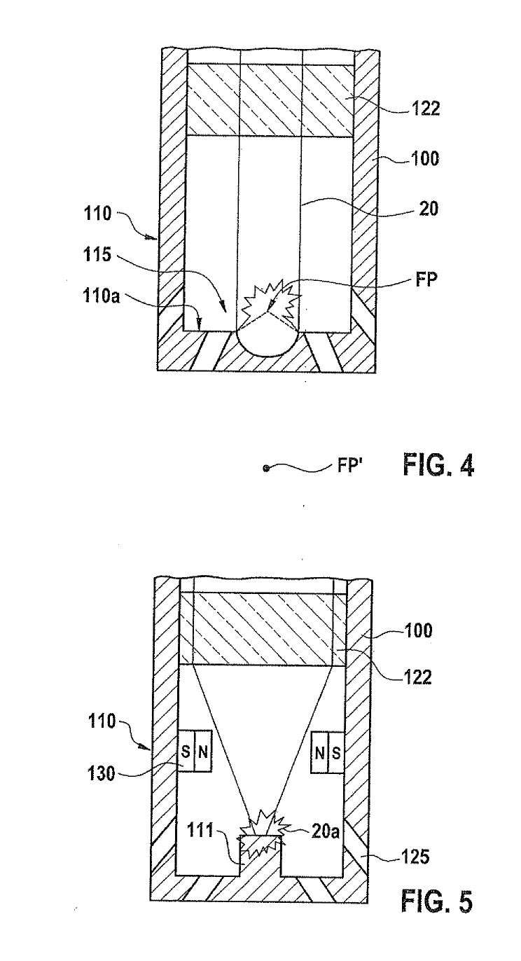

FIG. 4 shows another very advantageous specific embodiment of laser spark plug 100 according to the present invention, in which in the present case a focusing arrangement, designed as a concave mirror 115, is situated directly in prechamber 110. In this variant of the present invention, laser device 120 (FIG. 1) may emit laser pulses 20 onto focusing arrangement 115 in a generally unfocused manner, in particular as a parallel beam. By suitably selecting the geometry of concave mirror 115 according to the present invention, a very short focal length for concave mirror 115 may advantageously be achieved, so that focus point FP, which in the present case is established by prechamber 110, similarly as for the variant of the present invention described above, is located not directly on surface 110a, but instead in the region of the inner surface of an end region of prechamber 110 facing the combustion chamber. Concave mirror 115 may preferably have a parabolic cross-sectional shape, or may also be designed as a simple conical gap, thus simplifying manufacture.

As an alternative to emitting a parallel beam onto concave mirror 115, it is also possible, with the aid of laser device 120, 121, to focus laser pulses 20 on a virtual focus point FP′ located outside prechamber 110. In this case, laser pulse 20 having a nonvanishing beam cross section strikes focusing means 115 of prechamber 110, resulting in further focusing combined with a reflection of laser pulse 20 on “internal” focus point FP. A focusing lens 121 for this purpose in laser device 120, having a relatively long focal length, may be manufactured, with the same optical quality, much more easily than focusing lenses having a much shorter focal length which are used in conventional laser spark plugs. The use of aspherical focusing lenses, for example, in laser device 120 may thus be dispensed with, which greatly reduces the manufacturing costs.

Another very advantageous specific embodiment of laser spark plug 100 according to the present invention is illustrated in FIG. 5. In this variant of the present invention, a magnetic arrangement 130 is provided in the region of prechamber 110, which during the laser ignition attracts released magnetic particles and thus in a manner of speaking binds the particles, or, in the case of electrically charged particles, deflects the particles so that they do not reach the window, thus advantageously reducing soiling of combustion chamber window 122.

Magnetic arrangement 130 in particular may have ring magnets and/or multiple individual magnets peripherally situated about a longitudinal axis of laser spark plug 100, which are designed in particular as rare earth magnets (neodymium, samarium-cobalt, for example), which may have Curie temperatures >400° C. The use of electromagnets is also possible, provided that laser spark plug 100 has appropriate control lines. It is also possible to design and configure magnetic arrangement 130 in such a way that in addition to the function of particle binding, the magnetic arrangement, optionally together with flow-forming overflow passages 125, is able to influence the formation and motion of ignition plasma 20a.

Particularly efficient heat dissipation from prechamber 110 results from designing prechamber 110 in one piece with laser spark plug 100.

Alternatively, however, it is possible to implement prechamber 110 according to the present invention using a prechamber module 110 which is designed as a separate component. Separate prechamber module 110 may likewise have material buildup 111 according to the present invention, or a sacrificial material which is suitable for the laser ignition. It is also possible for a prechamber module 110 according to the present invention to have the focusing arrangement described above with reference to FIG. 4.

Prechamber module 110, designed as a separate component, may be nondetachably connected to the rest of laser spark plug 100 during a manufacturing process, for example. Alternatively, prechamber module 110 according to the present invention may have a design which is detachably connectable to laser spark plug 100, with the aid of an appropriate screw connection, for example.

Laser spark plug 100 according to the present invention and prechamber module 110 according to the present invention may be advantageously used in internal combustion engines of motor vehicles or also in large stationary gas engines. A timed multipulse ignition in which multiple laser pulses 20 are emitted within an ignition cycle may likewise be implemented by the present invention.

Provision according to the present invention of focus point FP in the region of inner surface 110a, in particular in an end region of prechamber 110 facing the combustion chamber, allows optimal ignition of the air/fuel mixture situated in main combustion chamber 200, with the overall result of improved combustion, and therefore higher power of the internal combustion engine and/or lower emissions.

1-13. (canceled)

14. A laser spark plug for an internal combustion engine of a motor vehicle, comprising:
a prechamber; and
a laser device to emit laser pulses into the prechamber;
wherein at least one of the laser device and the prechamber is configured to focus the laser pulses on a focus point located in a region of an inner surface of the prechamber.

15. The laser spark plug as recited in claim 14, wherein the laser device is configured to focus the laser pulses directly on the inner surface of the prechamber.

16. The laser spark plug as recited in claim 15, wherein the prechamber has a material buildup in a region of the focus point.

17. The laser spark plug as recited in claim 15, wherein the prechamber contains a sacrificial material in a region of the focus point which is different from material used for forming the rest of the prechamber, with respect to at least one of absorption capability for the laser pulses, a melting temperature, and further physical characteristics.

18. The laser spark plug as recited in claim 14, wherein the prechamber has a focusing arrangement for focusing the laser pulses.

19. The laser spark plug as recited in claim 18, wherein the focusing arrangement is a concave mirror.

20. The laser spark plug as recited in claim 18, wherein the focusing arrangement is one of a parabolic reflector or a conical gap.

21. The laser spark plug as recited in claim 18, wherein the laser device is configured to emit the laser pulses onto the focusing arrangement as one of a parallel beam, or on a point located outside the prechamber.

22. The laser spark plug as recited in claim 14, wherein the laser spark plug is designed in one piece with the prechamber.

23. The laser spark plug as recited in claim 14, wherein the prechamber contains a highly thermally conductive material.

24. The laser spark plug as recited in claim 14, wherein the prechamber contains at least one of copper and brass.

25. The laser spark plug as recited in claim 14, wherein a magnetic arrangement is provided in a region of the prechamber.

26. A prechamber module for a laser spark plug for an internal combustion engine of a motor vehicle, the prechamber module having at least one of a material buildup and a sacrificial material in a region of an inner surface for irradiation by laser pulses, the sacrificial material being different from material used for forming the rest of the prechamber module, with respect to at least one of absorption capability for the laser pulses, a melting temperature, and further physical characteristics.

27. A prechamber module for a laser spark plug for an internal combustion engine of a motor vehicle, the prechamber module including a concave mirror in a region of an inner surface for focusing laser pulses.

28. The prechamber module as recited in claim 12, wherein at least one wall section of the prechamber module has a layered design made of steel, having inserts made of highly thermally conductive material.

29. The prechamber module as recited in claim 28, wherein the highly thermally conductive material is at least one of copper and brass.
